(19) United States
(12) Patent Application Publication
(10) Pub. No.: US 2004/0178622 A1
(43) Pub. Date: Sep. 16, 2004

(54) Construction for a book jacket

(76) Inventor: Jeffrey L. Hengsbach, Mukwonago, WI (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/454,333

(22) Filed: Jun. 4, 2003

Related U.S. Application Data
(63) Continuation-in-part of application No. 10/315,422, filed on Dec. 10, 2002.
(63) Continuation-in-part of application No. 10/408,997, filed on Apr. 8, 2003.
Application No. 10/408,997 is a continuation-in-part of application No. 10/315,422, filed on Dec. 10, 2002.

(51) Int. Cl. B42D 3/00

(52) U.S. Cl. 281/29

(57) ABSTRACT

A book jacket which may be used in the manufacture of durable, high quality softbound or hardbound books is disclosed which is constructed of a transparent or semi-transparent jacket sheet having opposed first and second surfaces. The jacket sheet is printed on its second surface in multiple layers, including at least one printed layer of indicia which is applied in a wrong-reading orientation that appears in readable orientation when viewed from the first surface, or exterior surface of the book jacket. The improved book jacket of the present invention eliminates the need for paper book jackets requiring laminates or protective coatings before the book is shipped or sold. If desired, the improved book jacket of the present invention may be partially transparent, thereby allowing an image printed on the cover of the book to be visible therethrough, further adding to the depth of the visible images. The book jacket of the present invention also provides increased durability and strength over such conventional book jackets without the need to add a protective covering, while also having a superior glossy appearance over conventional book jacket constructions.

### IDENTIFICATION OF RELATED APPLICATIONS

This patent application is a continuation-in-part of U.S. patent application Ser. No. 10/315,422, filed on Dec. 10, 2002, entitled “CONSTRUCTION FOR A BOOK COVER,” and a continuation-in-part of U.S. patent application Ser. No. 10/408,997, filed on Apr. 8, 2003, entitled “CONSTRUCTION FOR A BOOK COVER,” which is in turn a continuation-in-part of U.S. patent application Ser. No. 10/315,422, filed on Dec. 10, 2002. Both of these patent applications are assigned to the assignee of the present invention, and both are hereby incorporated herein by reference.

### BACKGROUND OF THE INVENTION

Field of the Invention

The present invention relates generally to the field of book jacket manufacture, and more particularly to an improved construction for a book jacket and a method of making the improved book jacket.

A book jacket, also referred to as a dust jacket or dust-wrapper, is the paper wrapper that covers most hardbound books. A book jacket extends around the exterior cover of a book and folds around the edges of the book's front and back cover forming flaps. The book jacket conceals the outer front cover, the spine, and the outer back cover of the book, becoming the visible exterior surface of the book. Typically, a book jacket is not physically attached to the book in any manner.

Book jackets first appeared on hardbound books in the 1830s and were designed to protect the expensive covering materials such as cloth or leather from scuffing, rubbing, or fading of the book cover in the sun. Traditionally, dust jackets were intended to protect the book while the book was being transported from publisher to reader. These early dust jackets existed for purely utilitarian purposes and were routinely discarded by book owners.

Around the 1880s, books began to be sold with dust jackets having artwork or other decorative indicia. Book owners and libraries began to retain a book's jacket, not only for protection of the book, but also for the aesthetic appeal of the book's jacket. Indeed, these early book jackets are important to collectors today, and can represent up to half of the value of a collectible book. Depending on the artist or edition of the book, a book jacket can even be more valuable than the book itself.

Today, with such a large volume of books available to the public, a book's jacket plays a vital role in attracting attention on bookshelves stacked with hundreds of other books. Accordingly, hardbound books, and some softbound books, contain book jackets designed to distinguish a book from other similar books by including bright colors, extensive artwork, photographs, or special effects like a foiled or embossed finish on the book's jacket. A book jacket provides a book with a unique visual identity.

In addition to making a book stand out to prospective readers, a book's jacket also conveys important information about the book. This information includes information about the author, reviews of the book, credentials of the reviewers of the book, information pertaining to the audience for which the book was intended, and/or a summary of the book's contents. This information is intended to further distinguish the book from other books in the same subject area or fictional genre.

Traditionally, book jackets are produced starting first with a sheet of opaque, white paper such as eighty or one-hundred pound one side coated stock. The dimensions of the jacket sheet ultimately depend on the size of the book to be jacketed; however, each jacket sheet is long enough to be folded over on to the interior surface of the front and back covers to provide for front and back jacket flaps, respectively, which may contain additional information about the book and/or the author.

The paper sheet has two surfaces, namely, a top or first surface and a bottom or second surface. When the book jacket is placed on a book, the first surface of the sheet will become the exterior or outer surface of the book jacket (including the exterior or outer visible surface of the front and back jacket flaps) that will be viewed by a potential purchaser or reader. The second surface of the sheet will become the interior or inner surface of the book jacket which faces the book cover and is concealed when it is in place on the book. The second surface of the jacket sheet is typically left blank, and is typically white.

In the first step in the manufacturing process, the exterior front, spine, and back cover designs (including the title, author, or other bibliographical information) and the information intended to appear on the inside flaps of the book jacket are printed on the first surface of the paper sheet in a right-reading fashion. That is, the words and/or images are printed on the first surface of the sheet in the normal reading position and are not laterally reversed. Since the paper sheet is opaque, it will be appreciated that the printed words are readable only from the first surface of the sheet. The second surface is typically not printed, as it will be concealed by the book's cover.

Next, because the printed paper sheet will form the exterior covering for the book, and therefore will be exposed to damaging elements and abrasion, a protective top coat must be applied. Accordingly, after printing, the sheet is laminated with a thin material to protect the ink and paper from potential damage or destruction. Conventionally used laminate materials include polypropylene, polyester, polyvinyl, nylon, or similar materials of gauges generally ranging from 0.005 inch to 0.030 inch. Alternatively, a protective top coating may be applied to the first surface of the printed jacket sheet to protect the ink and the paper from damage. Commonly applied protective top coats include ultraviolet-cured coatings, water-based acrylics, varnish, or other similar materials.

After the protective coating is applied, the jacket can be trimmed or prepared in any manner before being mated with a book. Finally, with the book laying flat on its spine and with the front and back covers opened, the jacket is slipped under the spine and formed or folded around the front and back covers forming the inside flaps, and then the book is closed. This operation can be done in-line; however, it is not uncommon for a book jacket to be manually mounted onto a book.

A book's jacket, however, undergoes substantial stress and wear whenever the book is opened, stored, or transported. A paper book jacket may rapidly become torn or damaged, especially in the case of heavily-used books, such as those found in schools and libraries. Because a paper book jacket is easily ripped, scuffed, or otherwise damaged in appearance, many purchasers remove the book jacket after purchase and discard it, leaving the book cover completely unprotected.

Further, because of its fragility, a paper dust jacket is difficult to maintain in appearance, detracting from the collectible value of the book jacket. As dust jacket collecting becomes more common among book collectors, there is a growing economic incentive which discourages the practice of removing and throwing away original book jackets.

Even when the book's owner retains the book jacket, exposure to heat, oil, or moisture can cause the laminate coating to separate or curl away from the printed paper, or can cause the protective coating to be worn off, potentially destroying not only the ink and paper but the overall attractiveness and appearance of the book jacket. Further, exposure to the elements, especially in combination with the wear caused by repeated use of the book, can cause the book jacket to be completely destroyed, leaving the book cover unprotected and the book susceptible to significant damage.

Indeed, conventional paper book jackets have only a very thin laminate or UV coating, which provides little structural reinforcement to the thin paper book jacket, and provides little structural reinforcement to highly stressed portions of the book cover such as the corners, the hinges, or the spine. Consequently, even with a protective coating or laminate, a paper book jacket of conventional manufacture is not effective in increasing durability of a book for multiple readings or heavy use.

For these reasons, businesses, libraries, and classrooms attempt to protect their book jackets with protective book jacket covers, adding expense and additional work to the ownership of books. Conventional protective coverings include 1.5 mil to 2 mil polyester covers that can be either transparent or opaque and paper-backed. These protective covers are used to completely cover the book jacket. Typically, a book jacket cover will not require physical attachment to the original book jacket in order to preserve the integrity of the book jacket; however, less expensive book jacket covers require adhesives to adhere the protective covering to the book jacket or the book cover.

Book jackets covers come in a variety of predetermined sizes corresponding to the specific size of a book's cover. Unfortunately, such book jacket covers can be difficult and cumbersome to assemble onto the book jacket, and then onto the book. Alternatively, protective book jacket covers are available in rolls or sheets and require custom fitting to a particular book cover size, which is inefficient and time-consuming for large book collections.

These protective book jacket covers represent an additional expense and require extensive manual labor to fit on to a book's original book jacket or book cover. No matter how well the protective cover fits, the book jacket ornamental design and original printed indicia are obscured at least in part by the covering, significantly detracting from the book jacket's appearance. If a library call number is affixed to the inside flap or spine portion of the book jacket, a book jacket cover can also obscure that information.

In addition, because the protective covering may not fully enclose the book jacket, it tends to fall off, completely eliminating any protective function of the jacket. Further, protective book jacket covers become worn and must be replaced, significantly adding to material labor costs in large institutions such as schools and libraries. Further, if a library call number is on the book jacket cover, it must be reapplied every time the book jacket cover becomes worn and is exchanged.

For example, U.S. Pat. No. 5,029,900, to Axelrod, discloses a transparent, wrap-around cover used to protect books having multiple sizes of printed, laminated paper book covers, such as softbound books. The wrap around cover disclosed by the Axelrod patent must be carefully fitted around the book to the correct width or height, and contains flaps that are adhered to the wrap around cover in order to retain the front and back covers of the book in place. This type of book covering takes time to properly fit, and requires the user to have more than one size covering when fitting a large collection of books of differing sizes. Even when fitted onto a book, this type of covering does not have the attractive, lustrous appearance of a custom printed and fitted book jacket. Indeed, the disclosed wrap-around cover, although transparent, obscures or blocks much of the ornamentation on the book that it covers.

U.S. Pat. No. 4,505,497, to Katzman, discloses a multi-colored wrapper label, or book cover having readable data on both sides, with printing occurring only on one side of the wrapper label or cover. The Katzman invention discloses a transparent medium printed on its inside surface using individual pre-mixed spot colors, with each of five premixed colors applied one layer at a time, from dark to light in spots or patches on the transparent medium. Readable data appearing on the outside surface of the label is achieved by leaving unprinted subareas or portions of the transparent medium that are unprinted among the layer of the first, darkest color applied. The unprinted subareas correspond to the readable data in other words, the readable data is the stenciled out (ink free) portion remaining after the first, darkest layer is applied. Thus, in order for the label to appear with readable data on the outside surface, a second, lighter color of ink is applied, filling in the stenciled-out unprinted portions, and leaving unprinted subareas corresponding to readable data intended to appear on the inside surface of the label. In this way, subsequent layers of individual spot colors must occur from dark to light so that the previously printed color layer is not altered in appearance when viewed from the outside of the label.

If not applied in this manner, any overlap of the colors would distort any previously laid colors and blur the readable data. Because the colors are printed in patches or spots, overlapping layers of color, blends, and gradients do not print well, and printing full color photographs or multicolored graphics is simply out of the question using this method. In addition, because the colors must be premixed and limited in number to conserve costs, the type and variety of ornamentation applied to the transparent medium is significantly limited.

Even when book jacket protective covers are not worn or when they do not fall off, they provide little, if any, protective utility to the book cover, and the highly stressed portions of the book/book cover like the spine, corners, or the hinges.

It can be seen that conventional paper book jackets, even with a laminate or a protective coating, are fragile by nature and are not completely effective in protecting a book cover or a book's printed pages. In addition, paper book jackets easily scuff, fade in color and appearance, and loose the original shine when exposed to moisture, sun, or oil. Moreover, applying a laminate or a protective coating in the traditional process represents an additional step in the process requiring additional processing time, labor, equipment, and laminate or coating materials. Accordingly, it is desired to provide a book jacket that protects the book cover and/or book which is both durable and attractive in appearance, and which does not require an additional external protective cover, even under situations of heavy use.

It is accordingly the primary objective of the present invention to provide both an improved book jacket and a method for the manufacture of such an improved book jacket. The improved book jacket should be constructed from a transparent or substantially transparent plastic or other printable, transparent material to resist the sort of destruction which paper book jackets are subject to. It is a closely related objective of the present invention that the improved book jacket construction have increased durability over conventional book jacket constructions, and that it maximize protection of the printed ink, color, and design of the book jacket, as well as provide protection and reinforcement to the highly stressed portions of the book cover such as the corners, the hinge and the spine. The book jacket of the present invention should reduce the chance of damage or injury to a book whenever the book is shipped or transported.

It is another objective of the present invention to provide an improved book jacket construction in which the second or interior surface is the printed surface of the jacket while the first or exterior surface provides a high gloss appearance and protection for the printed ink, eliminating the need for subsequent lamination or UV coating of the printed side for protection of the book jacket. It is therefore a closely related objective that the improved book jacket construction of the present invention be more efficient to produce than conventional book jacket constructions. It is yet another objective of the present invention that the improved book jacket construction can be manufactured and subsequently joined to books without requiring substantial revision to an existing manufacturing process or investment in new equipment.

It is a further objective of the invention to provide an improved book jacket with a high gloss, impressive appearance that distinguishes the book cover over conventional book jackets. It is a related objective of the present invention to provide an improved book jacket construction that can additionally be foil stamped, embossed, spot varnished, or have various other special effects such as holograms added before the book cover is joined with a book.

It is another objective that the improved book jacket construction of the present invention is less expensive and more efficient to maintain than conventional book cover constructions by eliminating the need for libraries or schools to cover the book jackets with protective book jacket covers, thereby reducing the labor and expense of recovering book jackets as they become worn.

The improved book jacket of the present invention must also be of construction which is both durable and long lasting, and it should also require little or no repair to be provided by the user throughout its operating lifetime. In order to enhance the market appeal of the improved book jacket of the present invention, it should also be of inexpensive construction to thereby afford it the broadest possible market. Finally, it is also an objective that all of the aforesaid advantages and objectives of the improved book cover of the present invention be achieved without incurring any substantial relative disadvantage.

### SUMMARY OF THE INVENTION

The disadvantages and limitations of the background art discussed above are overcome by the present invention. With this invention, an improved book jacket is provided which is constructed of a transparent or substantially transparent plastic sheet, which is printed on its second surface in wrong-reading (laterally reversed or mirror-image) orientation, protecting the ink, color, and overall appearance of the book jacket. The plastic jacket sheet can be printed in multiple layers, adding to the unique visual effect of the book jacket.

Typically, the jacket sheet material of the present invention is provided on core rolls, and will first be “sheeted” or cut to a size predetermined by the final book requirements and the processing equipment. However, pre-sheeted material could also be used. In addition, the rolls of jacket sheet material can be printed using web-offset printing, and cut to the appropriate size after printing.

The material used for the jacket sheet includes such materials as polyester, nylon, vinyl, thermal laminating films such as materials sold under the registered trademark COVERLAM by Bryce Corporation or its licensees, high density polyethylene films such as those sold under the registered trademark VALERON by Illinois Tools Works, Inc. or its licensees, polystyrene, polypropylene, polyethylene, or any similar thin, transparent or substantially transparent material.

In addition, the jacket sheet will generally have a thickness from approximately 0.5 mils to approximately 7.0 mils. However, the thickness of the jacket material may also be influenced by the type and properties of the material selected for the book jacket. For example, the characteristic memory of the plastic or the density of the material may be a consideration. In addition, the type of book and the expected use of the book may also influence the type and thickness of material to be used as the book jacket. For example, in heavy-use applications, the book jacket may be constructed of a thick, more rigid material.

Once sheeted to the required size, the transparent jacket sheet will contain printable portions corresponding to the front cover flap, the front cover, the spine, the back cover, and the back cover flap of the completed book jacket. A printed layer corresponding to a title, an author, a design, or any other information intended to be located on the book jacket is applied to the second surface of the jacket sheet. The printed layer is applied to the second surface of the jacket sheet in a wrong-reading (laterally reversed or mirror-image) orientation such that, when the book jacket is joined to a book, the printed layer appears in a readable orientation when viewed from the first surface of the jacket sheet (which will correspond to the exterior surface of the book and the folded front and back cover flaps once the book jacket is mounted onto the book).

The printed layer may cover the entire second surface of the jacket sheet in a layer of ink corresponding to the complete book jacket design. However, the printed layer preferably covers only a portion of the second surface of the jacket sheet, allowing additional printed layers to be applied to the second surface of the jacket sheet, thereby enhancing the appearance of both the exterior surface of the book jacket and the inside flaps of the book jacket.

Accordingly, after the printed layer of ink is cured and/or dried, additional printed layers can be applied to the second surface of the jacket sheet, adding depth and improving the appearance of the exterior surface of the book. The additional printed layers can include additional artwork or additional information about the book. Further, the additional printed layers can include a backdrop of a single color such as white or black to contrast the first or previously printed layers, or a background design applied in multiple additional printed layers.

The additional printed layers may be applied to the second surface of the jacket sheet in either a wrong-reading (mirror-image) orientation or a readable orientation depending on the effect desired. Consequently, when viewed from the first surface of the jacket sheet or when viewed from the exterior surface of the assembled book, the exterior surface of the book jacket appears to be multidimensional or otherwise graphically unique.

In addition, before, after, and/or in between each layer of printing on the jacket sheet, the sheet may be foil stamped, embossed, spot varnished, or have any number of effects such as holograms added to either the first surface of the jacket sheet, or the second surface of the jacket sheet after any subsequent printed layers are cured and/or dried.

Finally, because the second surface of the book jacket will be the surface of the jacket sheet facing and concealed by the book cover, a solid printed layer may be applied to the second surface of the jacket sheet, such as a solid white layer, so that the second surface appears to contain no printing, or appears blank when the jacket sheet is viewed from the second (interior) surface. The second surface may however be printed to contain a pattern or design, although such a design would not be seen unless the book jacket is removed from the book.

Thus, when the jacket sheet is completed, the book's title, cover artwork, or other information intended to appear on the front cover flap, the front cover, the spine, the back cover, and the back cover flap of the completed book jacket is applied so that it is visible only from the first surface of the jacket sheet. That is, the information intended to appear on the exterior face/surface of the book, and on the front and back flaps may not be visible from the second surface/interior facing surface of the book jacket.

Alternatively, it may be desirable to have a “see-through” or partially transparent book jacket. In this instance, there may remain transparent or substantially transparent portions of the book jacket that do not contain ink, or which contain a transparent covering of ink, permitting one to literally look through the book jacket from the first surface of the jacket sheet to the images or words printed on the book cover of the book. This can give an added dimension of depth to add to the overall appearance of the book. For example, a book may have a character printed on the cover and the partially transparent book jacket may have an environment printed thereupon, such that when the book jacket is on the book the character is visible in the environment. The impression of depth which may be obtained is quite striking, and sets a book with such a cover and book jacket apart from other similar books which do not have this effect.

In further alternative embodiments of the present invention, the book jacket of the present invention may additionally contain printing on the first surface of the jacket sheet to create a more attractive book cover.

After printing, the jacket sheet is mated with a book such that the second surface of the jacket sheet faces the exterior surface of the book cover. To do this, the jacket sheet is slid, second surface side up, underneath a book laying open, spine side down, with the front and back covers laying flat. Excess jacket sheet that extends beyond the front and back covers is folded over on to the interior surface of the front and back covers forming the front and back flaps, respectively. This operation can be performed manually, or by conventional processing equipment.

It may therefore be seen that the present invention teaches both an improved book jacket and a method of making such an improved book jacket. The improved book jacket is constructed of a substantially transparent material such as plastic that is printed on its second surface, preferably in multiple layers, to achieve an attractive and dynamic appearing book jacket. The second surface of the jacket sheet is first printed in a wrong-reading orientation with the designs and information intended for the exterior surface of the book jacket, and the front and back flaps. Typically, the second surface is then printed with an opaque layer of ink, such as white, leaving the interior surface of the book jacket with an essentially unprinted appearance. Alternatively, however, the book jacket of the present invention can be constructed to contain unprinted or see-through portions.

The improved book jacket of the present invention has a more appealing and glossier appearance as compared to traditional book jacket constructions. Further, the improved book jacket of the present invention is attractive in appearance and highly durable, without the use of either lamination or UV coating. By eliminating the need for laminating or UV coating the book jacket, the improved book jacket of the present invention may be more efficient to produce than are conventional paper book jackets.

The book jackets of the present invention require no maintenance to preserve the appearance and integrity of the book jacket as originally manufactured. Thus, the book jacket construction eliminates the need for subsequent preservation of the book jacket with protective book jacket covers, saving money on materials and a significant amount of time and labor. Finally, the protective nature of the improved book jacket of the present invention eliminates damage to the book jacket and/or the book during shipping, decreasing the chances of damaged retail or library stock that must be returned, replaced, or repaired at the expense of the publisher.

The improved book jacket of the present invention is of a construction which is both durable and long lasting, and which will require little or no repair to be provided by the user throughout its useful lifetime. The book jacket of the present invention is also of relatively inexpensive construction to enhance its market appeal and to thereby afford it the broadest possible market. Finally, all of the aforesaid advantages and objectives of the improved book cover of the present invention are achieved without incurring any substantial relative disadvantage.

### DESCRIPTION OF THE DRAWINGS

These and other advantages of the present invention are best understood with reference to the drawings, in which:

FIG. 1 is a plan view of a nonprinted first or front surface of the jacket sheet used to construct the improved book jacket of the present invention, with a corner turned up to show a second or back surface thereof;

FIG. 2 is a plan view of the second surface of the jacket sheet illustrated in FIG. 1, showing wrong-reading (laterally reversed or mirror-image) indicia printed upon the second surface thereof;

FIG. 3 is a plan view of the first surface of the jacket sheet illustrated in FIGS. 1 and 2, with the indicia printed on the second surface being clearly visible in readable orientation through the jacket sheet;

FIG. 4 is a plan view of the second surface of the jacket sheet illustrated in FIGS. 1-3, showing a second layer of printed indicia applied to the jacket sheet upon the second surface thereof;

FIG. 5 is a plan view of the first surface of the jacket sheet illustrated in FIGS. 1-4, with the second layer of indicia being clearly visible in readable orientation through the jacket sheet;

FIG. 6 is a plan view of the second surface of the jacket sheet illustrated in FIGS. 1-5, showing a third layer of printed indicia applied to the jacket sheet upon the second surface thereof;

FIG. 7 is a cross-sectional view of the jacket sheet illustrated in FIGS. 1-6 along the line 7-7 shown in FIG. 6, showing the jacket sheet and the three layers of printed indicia;

FIG. 8 is a plan view of the second surface of the jacket sheet illustrated in FIGS. 1-7, showing additional layers of printed indicia applied to the jacket sheet upon the first surface thereof in readable orientation;

FIG. 9 is an isometric view of a book, showing indicia applied the exterior front cover, spine and back cover;

FIG. 10 is an isometric view of the book illustrated in FIG. 9, showing indicia applied to the interior front and back covers;

FIG. 11 is a plan view of the second surface of a jacket sheet constructed according to the teachings of the present invention, showing unprinted portions thereon;

FIG. 12 is a plan view of the first surface of the jacket sheet illustrated in FIG. 11, showing unprinted portions thereon;

FIG. 13 is an isometric view of the book illustrated in FIGS. 9 and 10 aligned with the jacket sheet illustrated in FIGS. 11 and 12, showing right and left edges of the jacket sheet extending beyond the right edge of the book's front cover and the left edge of the book's back cover, respectively;

FIG. 14 is a bottom side view of a book jacket constructed in accordance with the present invention joined with a book;

FIG. 15 is an isometric view of the book illustrated in FIGS. 9 and 10 joined with the book jacket illustrated in FIGS. 11 and 12, with the indicia applied to the book's exterior front cover, spine, and back cover being clearly visible through the jacket sheet within the unprinted portions thereon; and

FIG. 16 is an isometric view of the book illustrated in FIGS. 9 and 10 joined with the book jacket illustrated in FIGS. 11 and 12, with the indicia applied to the book's interior front and back covers being clearly visible through the jacket sheet within the unprinted portions present on the front and back flaps.

### DETAILED DESCRIPTION OF THE PREFERRED EMBODIMENT

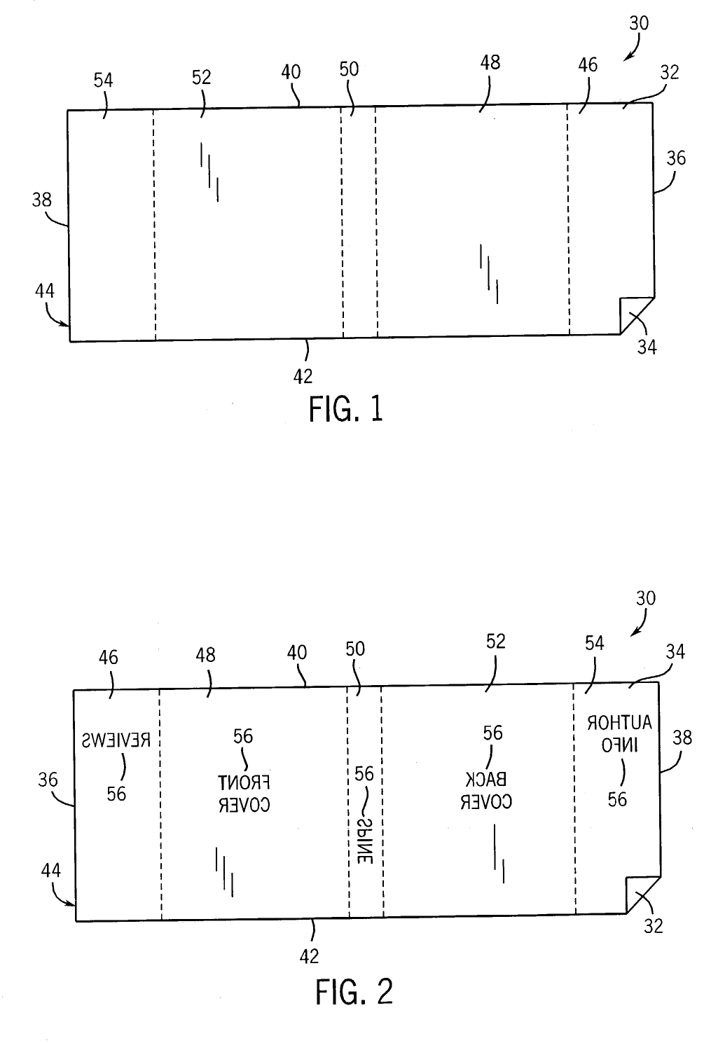

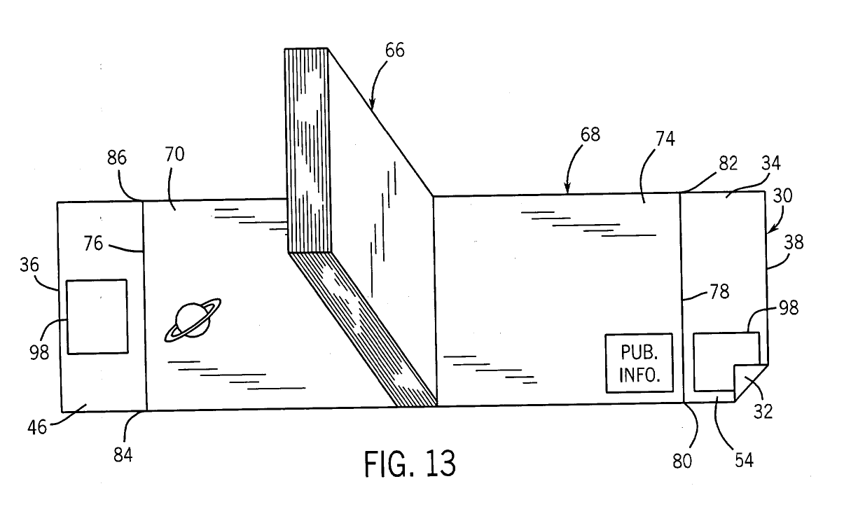

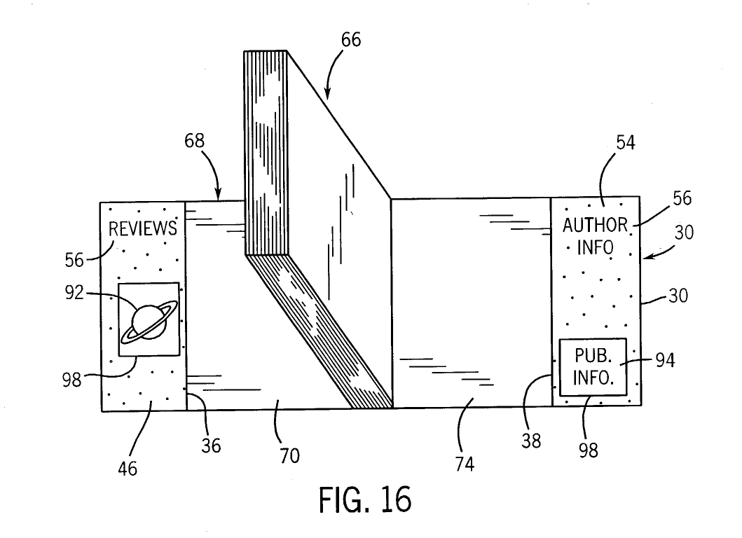

Consistent with the teachings of the present invention, the heart of an improved book jacket is a transparent or semi-transparent jacket sheet 30 of novel construction, illustrated in FIG. 1. The improved book jacket in its simplest form will consist of the jacket sheet 30, having a first or front surface 32 and a second or back surface 34. The sheet 30 may have multiple layers of printed indicia (not shown in FIG. 1) applied to the second surface 34 thereof, as discussed below in conjunction with FIGS. 2 through 12, and will then be joined with a book as discussed below in conjunction with FIGS. 13 and 16.

Referring now to FIG. 1, the construction of the jacket sheet 30 used in the manufacture of an improved soft book cover is described. In addition to the first surface 32 and the second surface 34, the jacket sheet 30 has a right edge 36, a left edge 38, a top edge 40, and a bottom edge 42. The first surface 32 of the jacket sheet 30 will become the exterior, readable surface of the book jacket when it is completely assembled on to the cover of a book. The second surface 34 of the jacket sheet 30 will become the interior surface of the book jacket (the surface that faces the book's front cover, spine, and back cover) when it is mounted onto the cover of a book.

The jacket sheet 30 is constructed of a flexible transparent or semi-transparent material. The transparent or semi-transparent material may be constructed of polyester, nylon, vinyl, thermal laminating films such as materials sold under the registered trademark COVERLAM by Bryce Corporation or its licensees, high density polyethylene films such as those sold under the registered trademark VALERON by Illinois Tools Works, Inc. or its licensees, polystyrene, polypropylene, polyethylene, or any similar thin, transparent or substantially transparent material. In addition, the jacket sheet 30 material may be tinted a visible color, provided that the jacket sheet 30 remains substantially transparent.

The jacket sheet 30 preferably has a thickness from approximately 0.5 mils to approximately 7.0 mils. However, the thickness of the jacket sheet 30 may be influenced by the type of material to be used for the book jacket, and, therefore, it is contemplated that the jacket sheet 30 may be thicker or thinner than the preferred thickness range. Accordingly, the jacket sheet 30 may be flexible if constructed of a relatively thin material, or the jacket sheet 30 may be relatively rigid if constructed of a relatively thick material.

In addition, the type of book and expected use of the book may also influence the type and thickness of material to be used for the book cover. For example, a book for circulation in a library may require a more durable book jacket, and therefore will have a book jacket constructed of a thicker or stronger jacket sheet material.

The transparent or semi-transparent material is typically supplied as a roll wound onto a core, and may be cut into sheets, thereby forming the jacket sheet 30. Alternatively, the transparent or semi-transparent material may be supplied from the manufacturer in pre-sheeted form and subsequently trimmed, if needed, to a specific size. Further, if the jacket sheet 30 material is provided on rolls, the jacket sheet 30 can alternatively be web printed, and then sheeted to a specific size.

The jacket sheet 30 will generally be rectangular in shape, and is sized corresponding to the requirements of the final book product, page size, and processing equipment requirements. However, in order to provide front and back cover flaps, the jacket sheet 30 will typically have a greater width than the combined width of the front cover, the spine, and the back cover of the book in which it is covering. It will at once be appreciated by those skilled in the art that the jacket sheet 30 can be of any shape or size required by the final book product.

As illustrated in FIG. 1, the jacket sheet 30 has an overall surface area, indicated generally at 44 which includes a front flap portion indicated generally at 46, a front cover portion indicated generally at 48, a spine portion located generally at 50, a back cover portion indicated generally at 52 and a back flap portion indicated generally at 54 (shown separated by dashed lines for illustrative purposes in FIG. 1). As will be explained in detail below, information printed within the front flap portion 46 of the jacket sheet 30 will appear on the front flap of the book jacket; information appearing on the front cover portion 48 will appear on the front cover of the book jacket; and information appearing on the spine portion 50 will appear on the spine of the book jacket. Likewise, information printed within the back cover portion 52 of the jacket sheet 30 will appear on the back cover of the book jacket, and information printed within the back flap portion 54 will appear on the back flap of the book jacket.

Referring next to FIGS. 2 and 3, a first layer of printed indicia 56 such as the book's title, cover image, and/or cover artwork intended to appear on the exterior surface of the book jacket is printed in a wrong-reading (laterally reversed or mirror image) orientation directly onto the second surface 34 of the jacket sheet 30. Accordingly, the first layer of printed indicia 56 appears in a mirror-image or wrong reading direction when viewed from the second surface 34 (as shown in FIG. 2). Because the jacket sheet 30 is transparent or semi-transparent, the first layer of printed indicia 56 is visible and appears in a right-reading (readable) orientation when viewed from the first surface 32 of the jacket sheet 30 (as shown in FIG. 3).

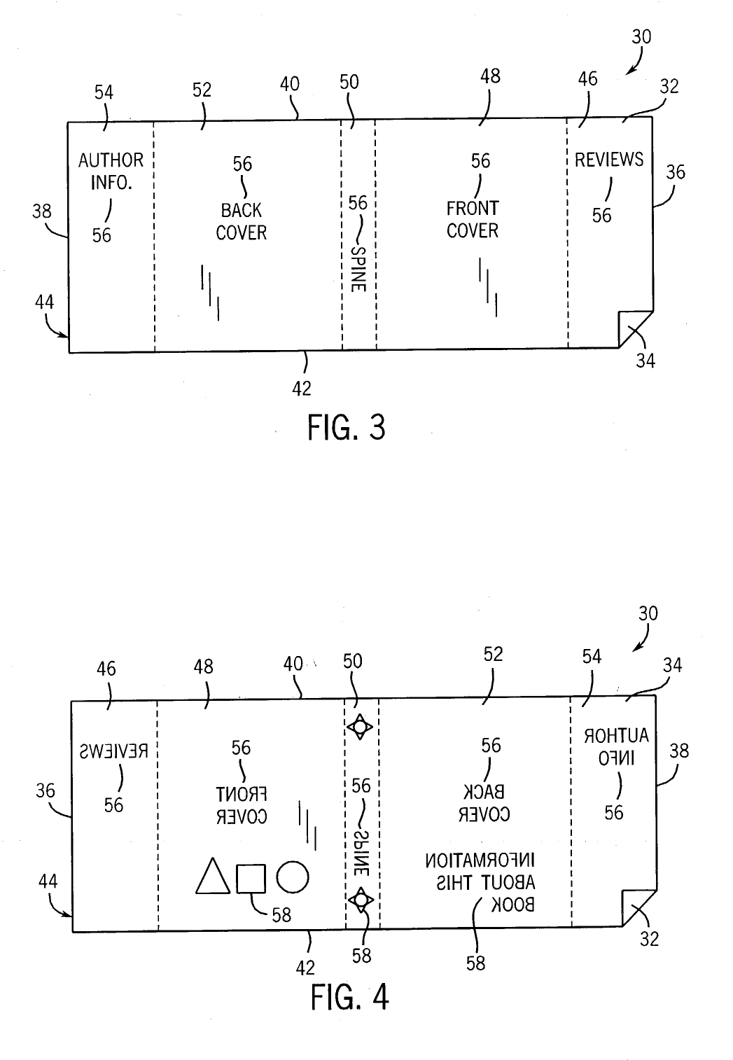

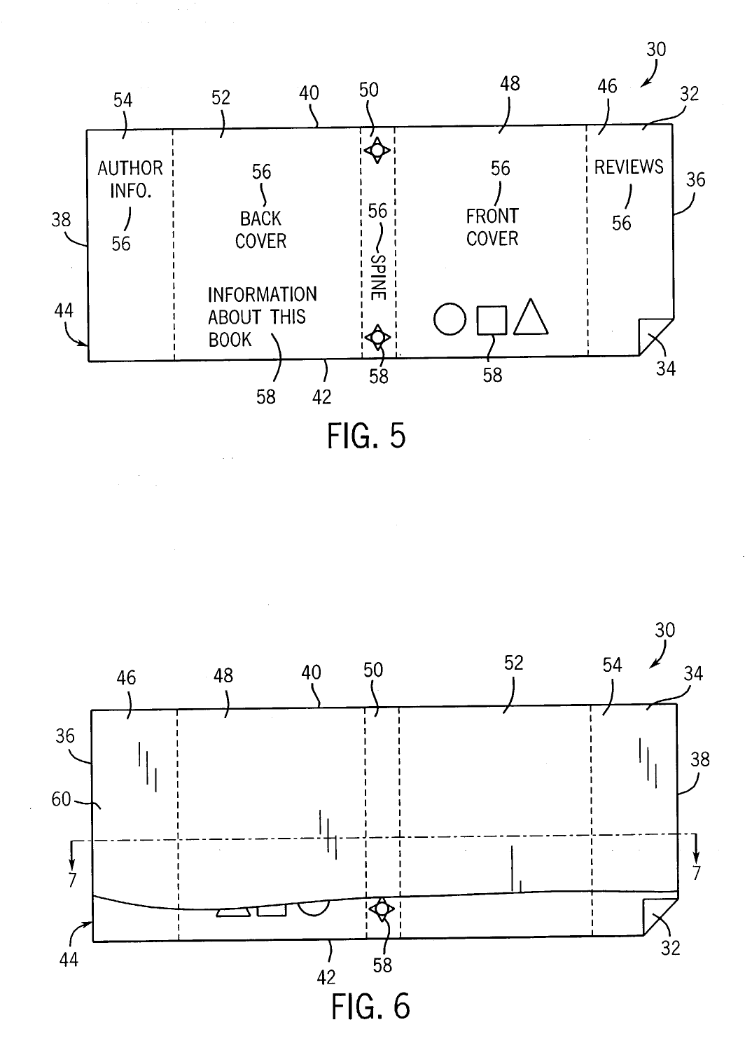

As illustrated in FIGS. 4 and 5, after the first layer of printed indicia 56 is cured and/or dried, a second layer of printed indicia 58 can be applied to the second surface 34 of the jacket sheet 30. The second layer of printed indicia 58 can include additional artwork, information about the book, or any other design that is intended to appear on the exterior surface of the jacket sheet 30 (which will be the exterior surface of the book and exterior surface of the interior flaps when the book jacket is mounted onto a book.)

As further illustrated in FIGS. 4 and 5, if the second layer of printed indicia 58 includes written words or images that must appear in a readable orientation when viewed from the first or exterior surface 32 of the jacket sheet 30, those words or images are printed in a wrong-reading orientation on the second surface 34 of the jacket sheet 30 over the first layer of printed indicia 56 (as shown in FIG. 4). Because the jacket sheet 30 is transparent or semi-transparent, any portion of the second layer of printed indicia 54 printed in wrong-reading orientation appears in a right-reading (readable) orientation when viewed from the first surface 32 of the jacket sheet 30 (as shown in FIG. 5).

However, if the second layer of printed indicia 58 includes images or designs that have no preferred readable orientation, or are essentially symmetrical, those images or designs can be printed in either a wrong-reading orientation or a right-reading (readable) orientation on the second surface 34 of the jacket sheet 30 over the first layer of printed indicia 56, depending on the effect desired (as shown in FIGS. 4 and 5).

It will be appreciated by those skilled in the art that the printed material intended to appear on the front flap, the front cover, the spine, the back cover, and the back flap of the book jacket may be printed in as many layers as desired or required to achieve a given visual effect. Such printed layers can add depth and intensify the visual effect of the exterior surface of the completed book jacket, enhancing the overall appearance of the book itself.

Accordingly, each of the printed layers 56 and 58 can cover as much or as little of the overall surface area 44 of the jacket sheet 30 as necessary to achieve the visual effect desired for the book jacket. For instance, each of the printed layers 56 and 58 may occupy only a portion of the overall surface area 44 of the jacket sheet 30, with subsequently applied printed layers being used to fill the non-printed portions of the overall surface area 44. Alternatively, a layering effect may be achieved by including printed layers that overlap each other on at least a portion of the overall surface area 44, leaving a portion of the overall surface area 44 of the jacket sheet 30 completely free from printing. Further, a printed layer can include 100% coverage of the overall surface area 44 of the jacket sheet 30.

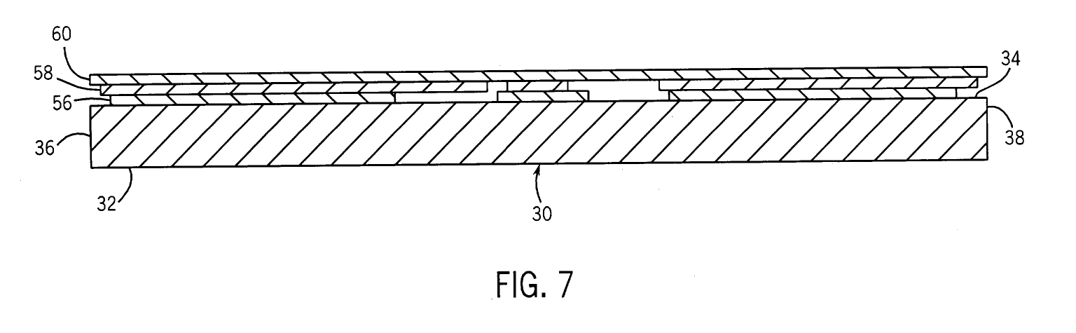

For example, after the second layer of printed indicia 58 is cured and/or dried, a third printed layer 60 can be applied to the second surface 34 of the jacket sheet 30 over the first and second layers of printed indicia 56, 58, as shown in FIGS. 6 and 7. The third printed layer 60 covers 100% of the overall surface area 44 (shown partially cut away near the bottom edge 42 for illustrative purposes in FIG. 6). The third printed layer 60 can be a multicolored backdrop overlaying the first and second layers of printed indicia 56 and 58, respectively, or the third printed layer 60 can be a solid color such as black or white to contrast the first and second layers of printed indicia 56 and 58, respectively.

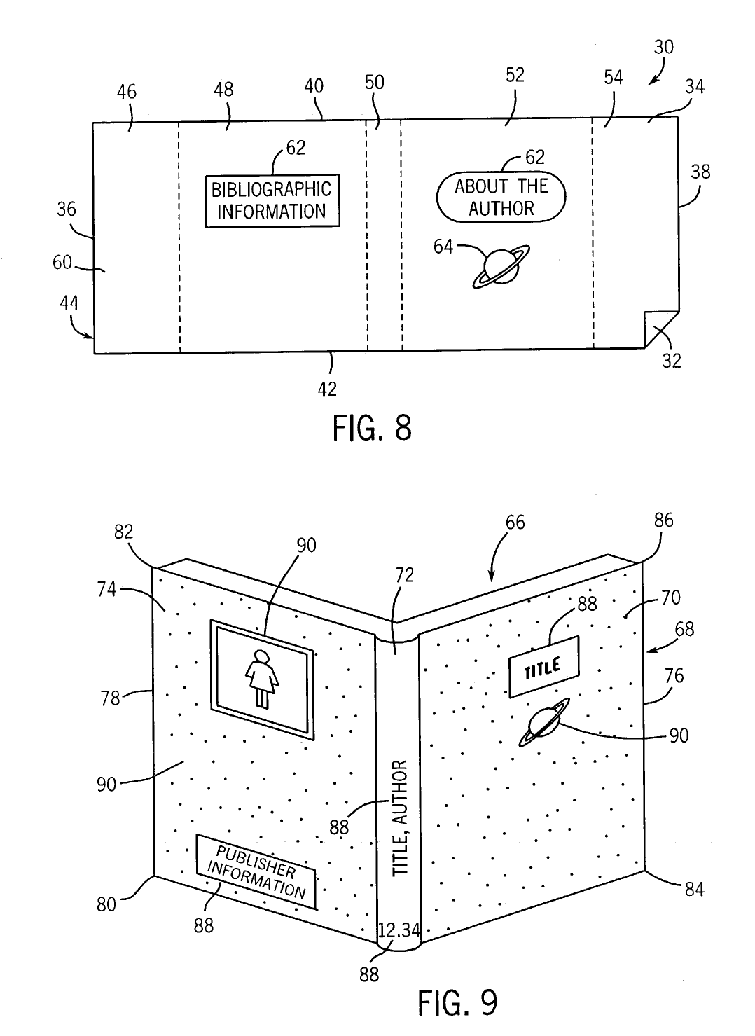

It will be apparent to those skilled in the art that when the book jacket is mounted onto a book the first surface will be the surface viewed, and the second (interior) surface of the jacket sheet 30 will be facing, and thus will be concealed by, the front cover, the spine, and the back cover of the book. Therefore, the last layer printed on to the second surface 34 of the jacket sheet 30 can be a solid color covering 100% of the overall surface area 44 so that the second surface contains no readable printed material, such as the indicia 60, illustrated in FIGS. 6 and 7. Alternatively, additional layers of indicia 62 and 64 can be printed on the second surface 34 of the jacket sheet 30 over the layers of indicia 56, 58, 60 so that the interior surface of the jacket sheet 30 contains printed information or designs which will be readable if the jacket is removed from the book, as illustrated in FIG. 8.

In addition, before, after, and/or in between each layer of printing, the jacket sheet 30 may be foil stamped, embossed, spot varnished, or have various other special effects/ornamentation, such as holograms, added to the second surface 34 of the jacket sheet 30. Other embodiments of the improved book jacket of the present invention can additionally include printed indicia, foil stamping, varnish, or other various effects, such as holograms, applied to the first surface 32 of the jacket sheet 30 either in addition to or instead of the printed indicia 56, 58, and 60 applied to the second surface 34 of the jacket sheet 30.

Moreover, as will become evident in FIGS. 9 through 15, the jacket sheet 30 may contain a portion of its overall surface area 44 that contains no printing at all and is completely free from ink, or contains only a transparent layer of ink, permitting the book jacket to have transparent or “see through” look when assembled with a book. Thus, any ornamentation or printed material appearing on the book's exterior front cover, the spine, or the back cover may be seen from the first surface 34 of the jacket sheet 30 through the front cover portion 48, the spine portion 50, or the back portion 52, respectively, depending on the overall coverage of the previously applied layers of ink. Likewise, any ornamentation or printed material appearing on the interior surface of the book's front or back covers may be seen from the first surface 34 of the jacket sheet 30 through the front flap portion 46 or the back flap portion 54, respectively.

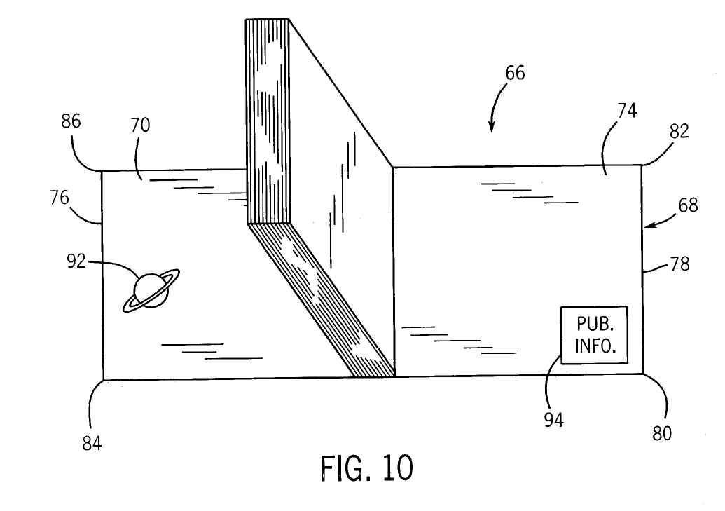

Referring to FIG. 9, a book 66 has a book cover 68 including a front cover 70, a spine 72, and a back cover 74. The book cover also contains a right edge 76, a left edge 78, and corners 80, 82, 84, and 86. The front cover 70, the spine 72, and the back cover 74 contain printed material 88 (such as the book's title, author, publisher information, and/or a library call number) and may also contain additional ornamentation 90 such as a hologram or embossing located on the exterior surface of the book cover 68. FIG. 10 illustrates the interior surface of the front cover 70 and the back cover 74 which may be embossed or may contain ornamentation 92 and/or printed material 94 such as publisher or copyright information.

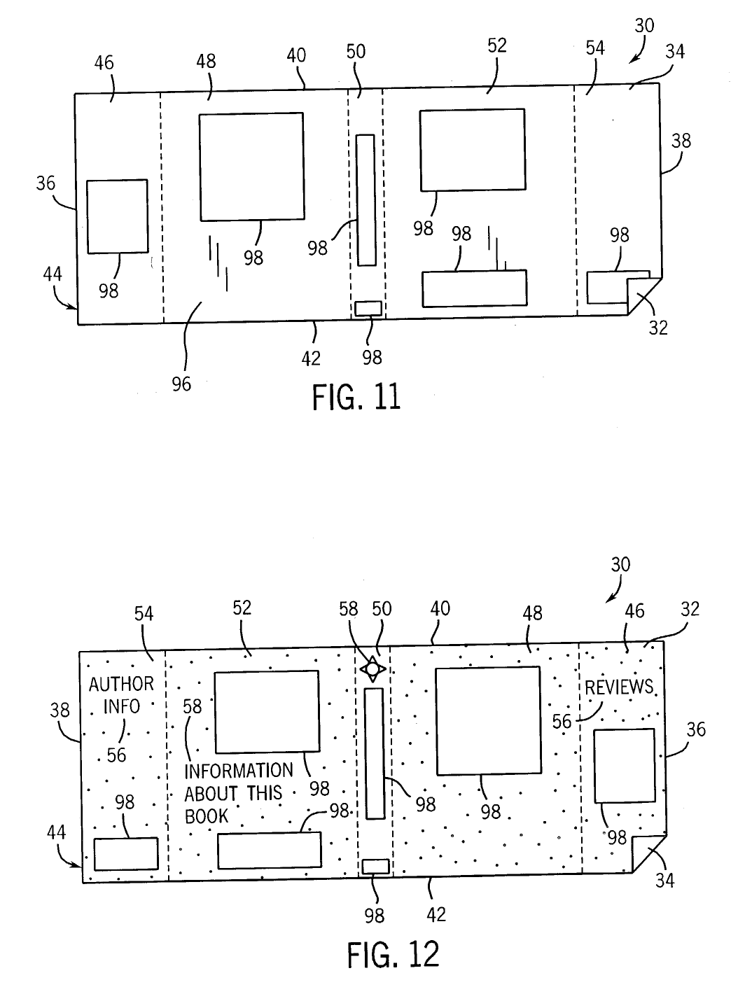

As illustrated in FIG. 11, the jacket sheet 30 contains a layer of indicia 96 printed on the second surface 34 of the jacket sheet 30 over the layers of indicia 56, 58. FIGS. 11 and 12 show that the indicia 56, 58, and 98 occupies only a portion of the overall surface area 44 of the jacket sheet 30, leaving see-through, unprinted portions 98 of the overall surface area 44 of the second surface 34 of the jacket sheet 30 completely unprinted and free from ink. The first surface 32 of the jacket sheet 30 thus has the portions 98 in addition to the printed indicia 56, 58, and 96, or any additional printed layers or special effects that encompass the complete book jacket design.

Layers of indicia are printed on the second surface 34 of the jacket sheet 30 using any one-color or multi-color sheetfed press known to those skilled in the art. Preferably, an ultraviolet (UV) cured ink will be used for printing. However, a heatset ink, a coldset ink, or any other conventional ink known to those skilled in the art, or any combination thereof, may also be used to print the layers of indicia on the second surface 34 of the jacket sheet 30. In addition, web offset printing may be used to print the jacket sheet 30 of the improved book jacket of the present invention. In the web-offset application, the transparent or semi-transparent material would be provided on rolls, and the material would be web-printed and subsequently cut into the jacket sheets 30 of the required size.

After the printing of the jacket sheet 30 is complete, the jacket sheet 30 can be trimmed or finished in any manner known to those skilled in the art in preparation for mounting the jacket sheet 30 on the book 66. If a thicker material is used for the jacket sheet 30, the sheet 30 may be scored to facilitate folding the right and left edges 36 and 38 of the jacket sheet 30 around the right and left edges 76 and 78 of the book cover 68, respectively. After finishing, the printed jacket sheet 30 is ready to be joined with the book 66.

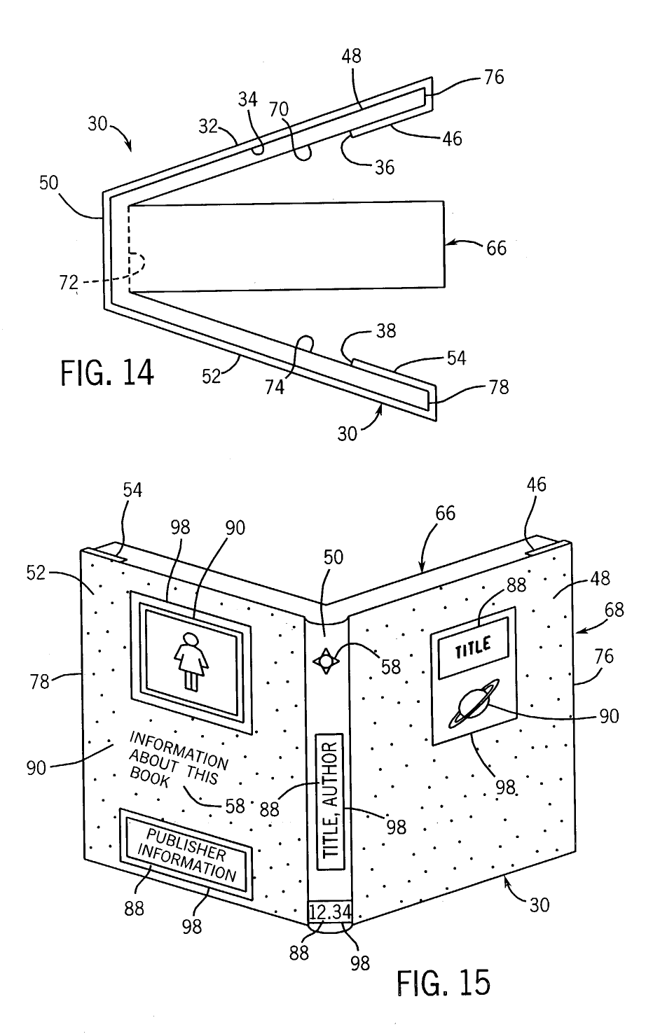

FIGS. 13 and 14 best illustrate how the jacket sheet is assembled with the book, forming the book jacket of the present invention. While the book 66 is laying flat with its front cover 70 and back cover 74 completely open (as shown in FIG. 10), the jacket sheet 30 is slipped, with its second surface 34 facing the exterior surface of the book's cover 68, underneath the book 66. The front cover portion 48, the spine portion 50, and the back cover portion 52 of the jacket sheet 30 are aligned with the front cover 70, the spine 72, and the back cover 74 of the book 66, and are thus not visible in FIG. 13. The right edge 36 of the jacket sheet 30 extends beyond the right edge 76 of the book cover 68, and the left edge 38 of the jacket sheet 30 extends beyond the left edge 78 of the book cover 68.

As illustrated in FIG. 14, the front flap portion 46 of the jacket sheet 30 is then folded around the right edge 76 of the book cover 68 so that the front flap portion 46 lies against the interior surface of the front cover 70 of the book 66. Likewise, the back flap portion 54 of the jacket sheet 30 is folded around the left edge 78 of the book cover 68 so that the back flap portion 54 lies against the interior surface of the back cover 74 of the book 66.

FIGS. 15 and 16 illustrate the jacket sheet 30 mounted on the book 66 to thereby form a book jacket. It can be seen that the printed material 88 and ornamentation 90 present on the exterior surface of the front cover 70, the spine 72, and the back cover 74 can be seen through the unprinted portions 98 of the jacket sheet 30 from the exterior/first surface of the book jacket. Likewise, the ornamentation 92 and the printed material 94 present on the interior surface of the front cover 70 and back cover 74 can be seen through the unprinted portions 98 of the jacket sheet 30 from exterior/first surface of the book jacket. As can be seen, the unprinted portions 98 of the jacket sheet 30, in addition to the layering effect of the ink applied to the second surface 34 of the jacket sheet 30, provide the book jacket with a multi-dimensional and more unique appearance than a conventional paper book jacket of conventional construction.

It may therefore be seen that the present invention teaches both an improved book jacket and a method of making such an improved book jacket. The improved book jacket of the present invention is constructed of a novel transparent or semi-transparent jacket sheet which is printed in multiple layers on the second surface of the jacket sheet. The jacket sheet is both durable and flexible, providing not only the book jacket, but the book and the book cover, with an enhanced useful life. Accordingly, the improved book jacket construction of the present invention protects the color and appearance of the book's outer surface better than a book cover constructed of laminated paper or paper-based material.

Further, it may be seen that the present invention provides an improved book jacket that is constructed of a plastic material which provides the book jacket with increased strength and durability, especially in highly stressed areas of the book jacket like the corners, hinges, and spine areas. As such, the improved book jacket of the present invention will outlast conventional book jackets, without requiring the additional expense of covering the book jacket to increase its life, as is commonly done today. The improved book jacket of the present invention additionally has a superior luster as compared to conventional book jackets.

Moreover, it may be seen that the present invention provides an improved book jacket that is noticeably more attractive and glossier in appearance than conventional book jackets, rendering the book product more eye-catching and appealing to consumers. The glossier appearance of the book jacket of the present invention further enhances the book jacket's printed images and wording, also rendering the book product more attractive to consumers.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. A book jacket comprising:
a substantially transparent sheet, said substantially transparent sheet having opposite first and second surfaces, and an overall surface area including a front flap portion, a front cover portion, a spine portion, a back cover portion, and a back flap portion; and
at least one layer of indicia applied to said second surface of said substantially transparent sheet, said indicia corresponding to information designated to appear on an exterior surface of the book jacket.

2. A book jacket as defined in claim 1, wherein at least a portion of said indicia is applied in a wrong reading orientation on said second surface of said transparent sheet.

3. A book jacket as defined in claim 1, wherein said substantially transparent sheet is made from a material selected from the group consisting of polyester, nylon, vinyl, thermal laminating film, high density polyethylene film, polystyrene, polypropylene, polyethylene, and any combination thereof.

4. A book jacket as defined in claim 1, wherein said substantially transparent sheet is tinted to a visible color.

5. A book jacket as defined in claim 1, wherein said substantially transparent sheet is foil stamped, embossed, hologrammed, or spot varnished on at least one of said first surface and said second surface.

6. A book jacket as defined in claim 1, wherein said substantially transparent sheet has indicia printed on said first surface thereof.

7. A book jacket as defined in claim 1, wherein said indicia is applied using ultraviolet-cured ink.

8. A book jacket as defined in claim 1, wherein said substantially transparent sheet contains a score line between at least one of said front flap portion and said front cover portion, said front cover portion and said spine portion, said spine portion and said back cover portion, and said back cover portion and said back flap portion to aid in forming said substantially transparent sheet around the cover of a book.

9. A book jacket for a book comprising:
a substantially transparent sheet, said substantially transparent sheet having first and second surfaces; and
a first set of indicia, wherein at least a portion of said first set of indicia is applied in a wrong-reading orientation to at least a portion of said second surface of said substantially transparent sheet.

10. A book jacket as defined in claim 9, wherein said first set of indicia comprises more than one layer of indicia applied to said second surface of said substantially transparent sheet.

11. A book jacket as defined in claim 9, wherein said substantially transparent sheet is made from a material selected from the group consisting of polyester, nylon, vinyl, thermal laminating film, high density polyethylene film, polystyrene, polypropylene, polyethylene, and any combination thereof.

12. A book jacket as defined in claim 9, wherein said substantially transparent sheet is tinted to a visible color.

13. A book jacket as defined in claim 9, wherein said substantially transparent sheet is foil stamped, embossed, hologrammed, or spot varnished on at least one of said first surface and said second surface.

14. A book jacket as defined in claim 9, wherein said first set of indicia is printed using ultraviolet-cured ink.

15. A book jacket as defined in claim 9, further comprising a second set of indicia, wherein at least a portion of said second set of indicia is applied in a right-reading orientation to at least a portion of said second surface of said substantially transparent sheet.

16. A book jacket as defined in claim 15, wherein said second set of indicia is applied to said second surface of said substantially transparent sheet at least partially over said first set of indicia.

17. A book jacket as defined in claim 15, wherein said second set of indicia comprises more than one layer of indicia applied to said second surface of said substantially transparent sheet.

18. A book jacket as defined in claim 15, wherein said transparent sheet comprises an overall surface area, wherein said first and said second sets of indicia are collectively applied to a portion of said transparent sheet comprising substantially all of said overall surface area.

19. A book jacket as defined in claim 15, wherein said transparent sheet comprises an overall surface area, wherein said first and said second sets of indicia are collectively applied to a portion of said transparent sheet leaving at least one second portion of said overall surface area unencumbered by indicia.

20. A book jacket as defined in claim 9, additionally comprising:
a third set of indicia applied to at least a portion of said first surface of said substantially transparent sheet.

21. A book jacket comprising:
a substantially transparent sheet, said substantially transparent sheet having first and second surfaces; and
an array of indicia applied to said second surface of said substantially transparent sheet.

22. A book jacket as defined in claim 21, wherein a portion of said indicia is applied to said second surface of said substantially transparent sheet in a wrong-reading orientation.

23. A book jacket as defined in claim 21, wherein a portion of said indicia is applied to said second surface of said substantially transparent sheet in a right-reading orientation.

24. A book jacket as defined in claim 21, wherein said substantially transparent sheet is made from a material selected from the group consisting of polyester, nylon, vinyl, thermal laminating film, high density polyethylene film, polystyrene, polypropylene, polyethylene, and any combination thereof.

25. A book jacket as defined in claim 21, wherein said substantially transparent sheet is foil stamped, embossed, hologrammed, or spot varnished on at least one of said first surface and said second surface.

26. A book jacket as defined in claim 21, wherein said substantially transparent sheet has indicia printed on said first surface.

27. A book jacket as defined in claim 21, wherein said array of indicia is applied using ultraviolet-cured ink.

28. A book jacket for a book, comprising:
a substantially transparent sheet, said substantially transparent sheet having opposite first and second surfaces, and an overall surface area including a front flap portion, a front cover portion, a spine portion, a back cover portion, and a back flap portion;
a first layer of indicia applied to said second surface of said substantially transparent sheet, said first layer of indicia covering at least a portion of said overall surface area of said substantially transparent sheet, said first layer of indicia being applied in one of a wrong-reading orientation and a right reading orientation to said second surface of said substantially transparent sheet; and
a plurality of additional layers of indicia applied to said second surface of said substantially transparent sheet, said additional layers of indicia covering at least a portion of said overall surface area of said substantially transparent sheet, said additional layers of indicia being applied in one of a wrong-reading orientation and a right reading orientation to said second surface of said substantially transparent sheet;
wherein said first layer and said additional layers of indicia correspond to the printed material designated to appear on said front flap portion, said front cover portion, said spine portion, said back cover portion, and said back flap portion of the book jacket.

29. A book jacket for a book, comprising:
a substantially transparent sheet, said substantially transparent sheet having opposite first and second surfaces, and an overall surface area including a front flap portion, a front cover portion, a spine portion, a back cover portion, and a back flap portion, wherein said substantially transparent sheet is made from a material selected from the group consisting of polyester, nylon, vinyl, thermal laminating film, high density polyethylene film, polystyrene, polypropylene, polyethylene, and any combination thereof; and
a set of indicia applied to said second surface of said front flap portion, said front cover portion, said spine portion, said back cover portion, and said back flap portion of said substantially transparent sheet, said set of indicia comprising at least one layer of indicia applied in a wrong-reading or a right reading orientation to at least a portion of said overall surface area of said substantially transparent sheet;
wherein said set of indicia is visible in right-reading orientation from said first surface of said substantially transparent sheet when said substantially transparent sheet is mounted to the book.

30. A method for making an improved book jacket comprising:
providing a substantially transparent sheet, said substantially transparent sheet having opposing first and second surfaces, and an overall surface area comprising a front flap portion, a front cover portion, a spine portion, a back cover portion and a back flap portion; and
applying a set of indicia to said second surface of said substantially transparent sheet.

31. A method for making an improved book jacket as defined in claim 30, wherein said applying step comprises:
applying a portion of said indicia to said second surface of said substantially transparent sheet in a wrong-reading orientation; and
applying a portion of said indicia to said second surface of said substantially transparent sheet in a right-reading orientation.

32. A method for making an improved book jacket as defined in claim 30, wherein said applying step comprises:
applying said array of indicia to a first portion of said substantially transparent sheet, wherein a second portion of said substantially transparent sheet is unencumbered by said indicia.

33. A method for making an improved book jacket as defined in claim 30, wherein said applying step comprises:
applying said array of indicia to said substantially transparent sheet covering substantially all of said overall surface area of said second surface of said substantially transparent sheet.

34. A method for making an improved book jacket as defined in claim 30, wherein said substantially transparent sheet is constructed of a material selected from the group consisting of polyester, nylon, vinyl, thermal laminating film, high density polyethylene film, polystyrene, polypropylene, polyethylene, and any combination thereof.

35. A method for making an improved book jacket as defined in claim 30, wherein said substantially transparent material is tinted to a visible color.

36. A method for making an improved book jacket as defined in claim 30, wherein said applying step comprises printing said set of indicia on said second surface of said sheet using a web-fed press.

37. A method for making an improved book jacket as defined in claim 30, wherein said applying step comprises printing said array of indicia on said second surface of said sheet using an ultraviolet-cured ink.

38. A method for making an improved book jacket as defined in claim 30, further comprising:
applying indicia to said first surface of said substantially transparent sheet.

39. A method for making an improved book jacket as defined in claim 30, further comprising:
scoring said substantially transparent sheet between at least one of said front flap portion and said front cover portion, said front cover portion and said spine portion, said spine portion and said back cover portion, and said back cover portion and said back flap portion to aid in forming said substantially transparent sheet around the cover of a book.

40. A method for making an improved book jacket as defined in claim 30, further comprising:
joining said substantially transparent sheet with a book having a front cover, a spine and a back cover, wherein said joining step comprises aligning said front cover portion, said spine portion, and said back cover portion with the exterior surface of the front cover, the spine and the back cover of the book, respectively, and folding said front flap portion and said back flap portion over on to the interior surface of the front cover and the back cover of the book respectively.

41. A method for making an improved book jacket as defined in claim 30, further comprising:
applying a further finishing effect to at least one of said first surface and said second surface.

42. A method for making an improved book jacket as defined in claim 41, wherein said further effect comprises foil stamping, embossing, hologramming, or spot varnishing.

43. A method for making an improved book jacket as defined in claim 30, wherein said applying step comprises printing said set of indicia on said second surface of said sheet using a sheetfed press.

44. A method for making an improved book jacket as defined in claim 39, wherein said sheetfed press is one of a one-color sheetfed press, a two-color sheetfed press, and a multi-color sheetfed press.

45. A method for making an improved book jacket as defined in claim 30, wherein said applying step comprises printing said set of indicia on said second surface of said sheet using a web press.

46. A method for making an improved book jacket comprising:
providing a substantially transparent sheet, said substantially transparent sheet having opposing first and second surfaces, and opposing right and left edges; and
applying a set of indicia to said second surface of said substantially transparent sheet, wherein at least a portion of said set of indicia is applied in a wrong-reading orientation, and wherein at least a portion of said set of indicia is applied in a right-reading orientation.

47. A method for making an improved book jacket as defined in claim 46, wherein said applying step further comprises:
applying said set of indicia to a first portion of said substantially transparent sheet, wherein at least one second portion of said substantially transparent sheet is unencumbered by said set of indicia.

48. A method for making an improved book jacket as defined in claim 46, wherein said applying step further comprises:
applying said set of indicia to said substantially transparent sheet to cover substantially all of said second surface of said substantially transparent sheet.

49. A method for making an improved book jacket as defined in claim 46, further comprising:
mating said substantially transparent sheet with a book having a front cover, a spine, and a back cover, the front and back covers of the book having opposing exterior and interior surfaces;
wherein said mating step comprises aligning said second surface of said substantially transparent sheet with the exterior surfaces of the front cover, the spine and the back cover of the book so that said right and left edges of said substantially transparent sheet extend beyond said front and back covers, respectively, and folding said right and left edges of said substantially transparent sheet over on to the interior surfaces of the front cover and the back cover of the book, respectively.

50. A method for making an improved book jacket comprising:
providing a substantially transparent material;
cutting said substantially transparent material into a substantially rectangular sheet, said sheet having a first surface and a second surface; and
applying a set of indicia to a portion of said second surface of said sheet.

51. A method for making an improved book jacket as defined in claim 50, further comprising:
applying a further effect to one of said sheet, said further effect comprising foil stamping, embossing, hologramming, or spot varnishing said sheet on at least one of said first surface and said second surface.

52. A method for making an improved book jacket as defined in claim 50, wherein said applying step further comprises:
applying a first portion of said indicia to said second surface of said substantially transparent sheet in a wrong-reading orientation; and
applying a second portion of said indicia to said second surface of said substantially transparent sheet in a right-reading orientation.

53. A method for making an improved book jacket as defined in claim 50, wherein said applying step further comprises:
applying said indicia to a portion of said substantially transparent sheet comprising substantially all of said second surface of said transparent sheet.

54. A method for making a book jacket comprising:
providing a substantially transparent sheet having a first surface, a second surface, and an overall surface area comprising a front flap portion, a front cover portion, a spine portion, a back cover portion and a back flap portion;
applying a set of indicia to said second surface of said substantially transparent sheet;
providing a book containing a front cover, a spine, and a back cover, each of said front cover, spine and back cover having an exterior surface and an interior surface;
aligning said second surface of said front cover portion, said spine portion, and said back cover portion of said substantially transparent sheet with the exterior surface of the front cover, the spine and the back cover of the book, respectively; and
folding said front flap portion and said back flap portion of said substantially transparent sheet over on to the interior surface of the front cover and the back cover of the book respectively.
